(19) United States
(12) Patent Application Publication
(10) Pub. No.: US 2026/0221787 A1
(43) Pub. Date: Jul. 30, 2026

(54) ELECTRONIC DEVICE AND METHOD FOR CONTROLLING MULTI-BATTERY OF ELECTRONIC DEVICE

(71) Applicant: Samsung Electronics Co., Ltd., Suwon-si (KR)

(72) Inventor: Seungjun LEE, Suwon-si (KR)

(21) Appl. No.: 19/572,152

(22) Filed: Mar. 19, 2026

Related U.S. Application Data
(63) Continuation of application No. PCT/KR2024/096448, filed on Oct. 31, 2024.

(30) Foreign Application Priority Data
Nov. 6, 2023 (KR) 10-2023-0152104
Nov. 28, 2023 (KR) 10-2023-0168182

(51) Int. Cl. H02J 7/50; H02J 7/82; H02J 7/84; H02J 7/90; H02J 105/44

(52) U.S. Cl. CPC H02J 7/50; H02J 7/82; H02J 7/84; H02J 7/933; H02J 2105/44

(57) ABSTRACT

An electronic device is provided. The electronic device includes on-keys exposed to an outside of a housing so as to be pressed or released by physical pressure, a plurality of batteries, a power management circuit for managing power supplied from the batteries to each component of the electronic device, a multi-battery management circuit, memory, comprising one or more storage media, storing instructions, and at least one processor communicatively coupled to the memory, wherein the multi-battery management circuit includes a plurality of battery switches arranged on a plurality of battery paths connected to the plurality of batteries, respectively, so as to connect or block the battery paths, and a plurality of on-key switches arranged on on-key paths corresponding to the plurality of battery switches, respectively, so as to connect or block the on-key paths according to pressing or releasing of the on-keys.

### CROSS-REFERENCE TO RELATED APPLICATION(S

This application is a continuation application, claiming priority under 35 U.S.C. § 365(c), of an International application No. PCT/KR2024/096448, filed on October 31, 2024, which is based on and claims the benefit of a Korean patent application number 10-2023-0152104, filed on November 6, 2023, in the Ministry of Intellectual Property (MOIP), and of a Korean patent application number 10-2023-0168182, filed on November 28, 2023, in the Ministry of Intellectual Property (MOIP), the disclosure of each of which is incorporated by reference herein in its entirety.

### BACKGROUND

### 1. Field

The disclosure relates to an electronic device, for example, an electronic device that includes a plurality of batteries.

### 2. Description of Related Art

A portable electronic device (hereinafter, electronic device), such as a smartphone and a tablet personal computer (PC), needs to be guaranteed to be portable, so may operate with the power of a battery. For example, the battery of the electronic device may be configured as a rechargeable secondary battery, and the battery may be charged through an external charger and each component of the electronic device may operate with the power of the battery. Due to its chemical property, the battery does not have an infinite lifespan. As charging and recharging is repeatedly performed, its maximum charge capacity may gradually decrease. In particular, when the battery is fully discharged, it may have a greater impact on the battery lifespan.

The electronic device may include two or more batteries for reasons such as an increased usage time through securing the high battery capacity or the spatial arrangement structure. When the battery includes two or more multiple batteries, the remaining capacity of each battery may be balanced by alternately using the power of each battery according to various algorithms.

The above information is presented as background information only to assist with an understanding of the disclosure. No determination has been made, and no assertion is made, as to whether any of the above might be applicable as prior art with regard to the disclosure.

### SUMMARY

Some leakage current may occur in an electronic device even in a power-off state. Therefore, if the power-off state is maintained during a long period of time, a battery may be fully discharged, shortening its battery lifespan. Alternatively, a predetermined period of time is required to recharge before powering the electronic device on, which may be inconvenient for a user. Even in an electronic device that includes a multi-battery, leakage current from each battery may cause all batteries to be fully discharged.

Aspects of the disclosure are to address at least the above-mentioned problems and/or disadvantages and to provide at least the advantages described below. Accordingly, an aspect of the disclosure is to provide an electronic device that includes a plurality of batteries.

Additional aspects will be set forth in part in the description which follows and, in part, will be apparent from the description, or may be learned by practice of the presented embodiments.

In accordance with an aspect of the disclosure, an electronic device is provided. The electronic device includes an on-key exposed to an outside of a housing and configured to be capable of being pressed or released by physical pressure, a plurality of batteries, a power management circuit configured to manage power supplied from the batteries to each component of the electronic device, a multi-battery management circuit, memory, comprising one or more storage media, storing instructions; and at least one processor communicatively coupled to the memory, wherein the multi-battery management circuit includes a plurality of battery switches arranged on a plurality of battery paths connected to the plurality of batteries, respectively, and configured to connect or disconnect the battery paths, and a plurality of on-key switches arranged on on-key paths corresponding to the plurality of battery switches, respectively, and configured to connect or disconnect each of the on-key paths depending on press or release of the on-key, and wherein the instructions, when executed by the at least one processor individually or collectively, cause the electronic device to detect a power-off event of the electronic device, in response to the power-off event, select a single battery to be used for power-off sequence corresponding to the power-off event from among the plurality of batteries based on state information of each of the plurality of batteries, and connect an on-key path corresponding to a battery path of at least one battery other than the selected battery to a battery switch corresponding to the battery path of the at least one battery, such that the battery switch closes and opens depending on press or release of the on-key.

In accordance with another aspect of the disclosure, a multi-battery control method of an electronic device is provided. The multi-battery control method includes detecting a power-off event of the electronic device, in response to the power-off event, identifying state information of each of a plurality of batteries, selecting a single battery to be used for a power-off sequence corresponding to the power-off event based on the state information of each of the plurality of batteries, and connecting an on-key path corresponding to a battery path of at least one battery other than the selected battery to a battery switch corresponding to the battery path of the at least one battery, such that the battery switch closes or opens depending on press or release of an on-key of the electronic device.

In accordance with another aspect of the disclosure, one or more non-transitory computer-readable storage media storing one or more computer programs including computer-executable instructions that, when executed by one or more processors of an electronic device individually or collectively, cause the electronic device to perform operations are provided. The operations including detecting a power-off event of an electronic device, in response to the power-off event, identifying state information of each of a plurality of batteries, selecting a single battery to be used for power-off sequence corresponding to the power-off event, based on state information of each of the plurality of batteries, and connecting an on-key path corresponding to a battery path of at least one battery other than the selected battery to a battery switch corresponding to the battery path of the at least one battery, such that the battery switch closes or opens depending on press or release of an on-key of the electronic device.

According to various embodiments of the disclosure, a multi-battery control method of an electronic device that prevents all batteries from being discharged and ensures a required battery level when powering on the electronic device, by stably and efficiently disconnecting some batteries and a system when powering off the electronic device that includes a multi-battery and thereby blocking leakage current is provided.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a block diagram of an electronic device according to an embodiment of the disclosure;

FIG. 3 is a block diagram including a battery path of a multi-battery of an electronic device according to an embodiment of the disclosure;

FIG. 4 is a circuit diagram of an on-key path of a multi-battery management circuit according to an embodiment of the disclosure;

FIGS. 5A and 5B illustrate an operation of disconnecting one battery path when powering off an electronic device according to various embodiments of the disclosure;

FIGS. 6A and 6B illustrate an operation of connecting a battery path that was disconnected when turning on due to on-key press of an electronic device according to various embodiments of the disclosure;

FIGS. 7A and 7B illustrate an operation of connecting a battery path that was disconnected when turning on due to connection of an external charger to an electronic device according to various embodiments of the disclosure;

FIG. 8 illustrates an operation of disconnecting one battery path when an electronic device performs alarm booting according to an embodiment of the disclosure; and

FIG. 9 is a flowchart of a multi-battery control method of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

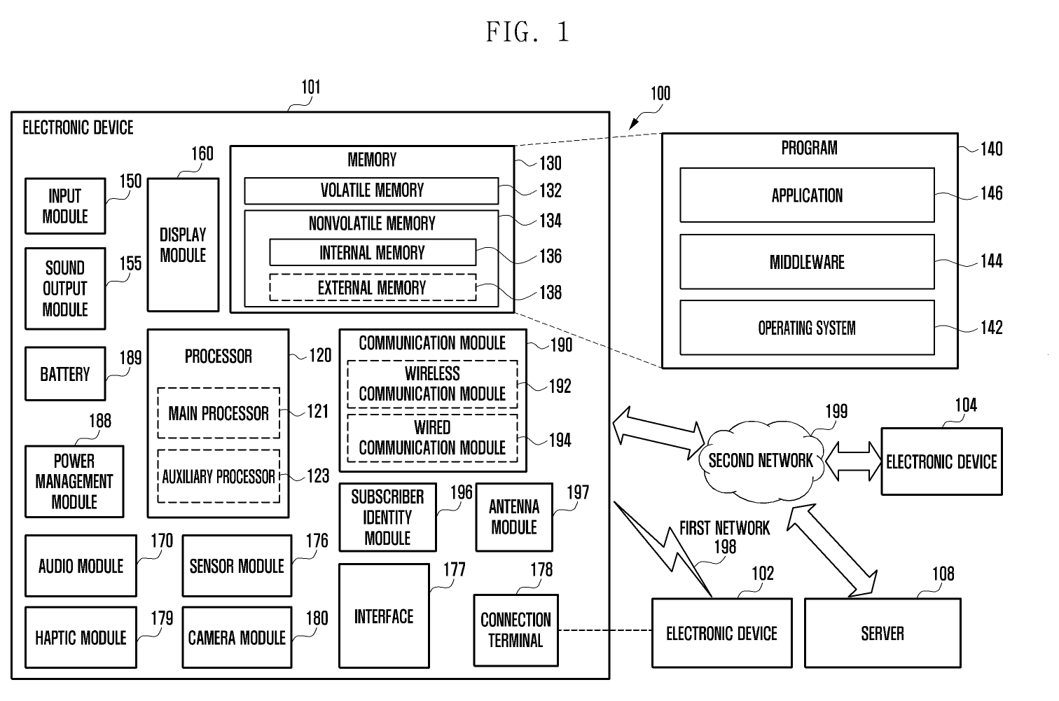

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth^{TM}, wireless-fidelity (Wi-Fi) direct, or infrared data association (IrDA)) or the second network 199 (e.g., a long-range communication network, such as a legacy cellular network, a 5^{th} generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4^{th} generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter-wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or user plane (U-plane) latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

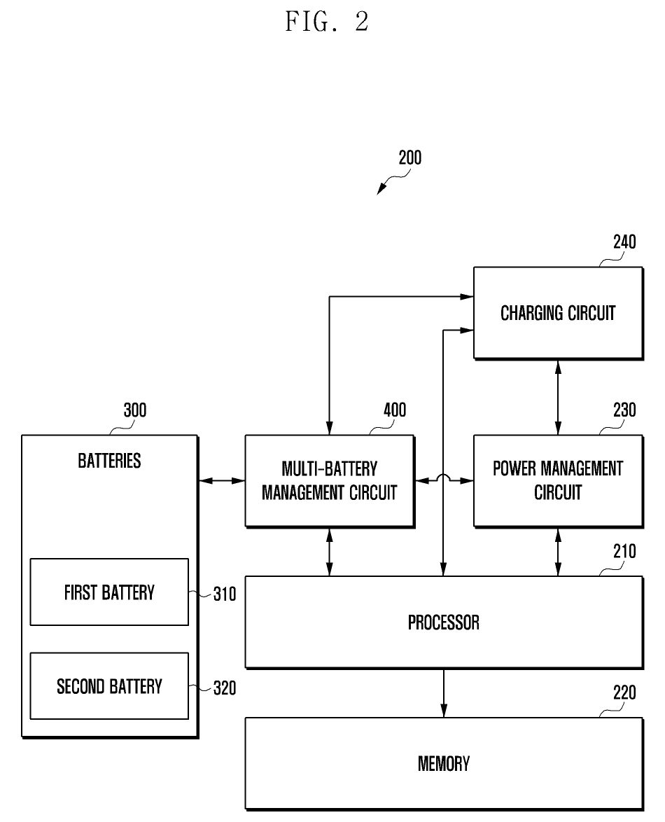

FIG. 2 is a block diagram of an electronic device according to an embodiment of the disclosure.

Referring to FIG. 2, an electronic device 200 may include a plurality of batteries 300, a multi-battery management circuit 400, a charging circuit 240, a power management circuit 230, a processor 210, and memory 220. Although some of the illustrated components are omitted or replaced with other components, various embodiments of the disclosure may be implemented. In addition to the illustrated components, the electronic device 200 may further include at least some of the components and/or functions of the electronic device 101 of FIG. 1. At least some of the components of the electronic device 200 may be operatively, electrically, and/or functionally connected to each other.

According to an embodiment, the electronic device 200 may be implemented in a foldable type. The foldable type of the electronic device 200 may include a first housing and a second housing, and the first housing and the second housing may be rotatably connected to each other through a hinge structure arranged therebetween. For example, the electronic device 200 may include a foldable structure that may be folded left and right based on a vertical folding axis, or may include a foldable structure that may be folded up and down based on a horizontal folding axis. According to an embodiment, a flexible display (not shown) may be arranged on the first housing and the second housing, and the flexible display may be folded based on the folding axis.

According to another embodiment, the electronic device 200 may be implemented as not the foldable type, but, for example, a bar type or a slidable type of the electronic device 200. Various embodiments of the disclosure are not limited to a form factor of the electronic device 200.

According to an embodiment, the electronic device 200 may include the plurality of batteries 300. Herein, the electronic device 200 will be described as including a first battery 310 and a second battery 320, but the electronic device 200 may include three or more batteries, and various embodiments of the disclosure may be applied even when the electronic device 200 includes three or more batteries.

According to an embodiment, when the electronic device 200 is implemented as a foldable device, at least one (e.g., first battery 310) of the plurality of batteries 300 may be arranged within the first housing, and at least another one (e.g., second battery 320) may be arranged within the second housing.

According to an embodiment, the power management circuit 230 may manage power that is supplied from the plurality of batteries 300 to each component of the electronic device 200. For example, the power management circuit 230 may provide voltage or current required to operate various components that include the processor 210, may manage charging of the batteries 300 based on power supplied from an external charger, and may perform various operations, such as power consumption optimization and/or power scheduling and control. According to an embodiment, power supplied from the batteries 300 may be distributed to each component of the electronic device 200 by way of the power management circuit 230, and for some components (e.g., power amp of radio frequency (RF) front end), the power may be directly supplied from the batteries 300 through a battery path without going through the power management circuit 230. The power management circuit 230 may further include at least some of components and/or functions of the power management module 188 of FIG. 1.

According to an embodiment, the charging circuit 240 may be arranged in an electrical path between the multi-battery management circuit 400 and the power management circuit 230. When the external charger (travel adapter (TA)) is connected, the charging circuit 240 may supply charging power of the external charger to the batteries 300, thereby charging the batteries 300. The external charger may supply charging power in a wired charging manner or a wireless charging manner.

According to an embodiment, the multi-battery management circuit 400 may be arranged in an electrical path between the batteries 300 and the power management circuit 230. The multi-battery management circuit 400 may include at least some of battery paths through which power is supplied or charged from the batteries 300, respectively. For example, the multi-battery management circuit 400 may include a first battery path including a discharge path through which the power of the first battery 310 is output to the power management circuit 230 or components and a charge path through which the power is supplied from the external charger and the charging circuit 240 to the first battery 310, and a second battery path including a discharge path through which the power of the second battery 320 is output to the power management circuit 230 or the components and a charge path through which the power is supplied from the external charger and the charging circuit 240 to the second battery 320.

According to an embodiment, a battery switch (not shown) may be arranged in a battery path of each of the plurality of batteries 300 to connect or disconnect the battery path. For example, a first battery switch that may connect or disconnect the first battery path may be arranged in the first battery path, and a second battery switch that may connect or disconnect the second battery path may be arranged in the second battery path.

According to an embodiment, the multi-battery management circuit 400 may include a plurality of on-key switches (e.g., first on-key switch, second on-key switch) arranged in on-key paths (e.g., first on-key path, second on-key path) corresponding to the plurality of battery switches (e.g., first battery switch, second battery switch), respectively, and may connect or disconnect each of the on-key paths, depending on press or release of the corresponding on-key. According to an embodiment, the on-key (not shown) may be arranged to be exposed to the outside of the housing (e.g., housing side surface) of the electronic device 200, and may be at least partially protruded to be pressed by a user with the hand. The one-key may remain in a released state without physical pressure from the outside, and may be pressed when the physical pressure is applied.

According to an embodiment, when the first on-key path is connected to the first battery path (or first battery switch), a control signal that may turn on/off the first battery switch depending on press or release of the on-key may be provided to the first battery switch, and when the second on-key path is connected to the second battery path (or second battery switch), a control signal that may turn on/off the second battery switch depending on press or release of the on-key may be provided to the second battery switch. When the first on-key path includes the first on-key switch, the second on-key path includes the second on-key switch, and the user presses the on-key arranged on the outside of the electronic device 200, the first on-key switch and the second on-key switch may be closed.

According to an embodiment, the multi-battery management circuit 400 may include the first on-key path switch configured to connect or disconnect the first battery path (or first battery switch) and the first on-key path, and the second on-key path switch configured to connect or disconnect the second battery path (or second battery switch) and the second on-key path.

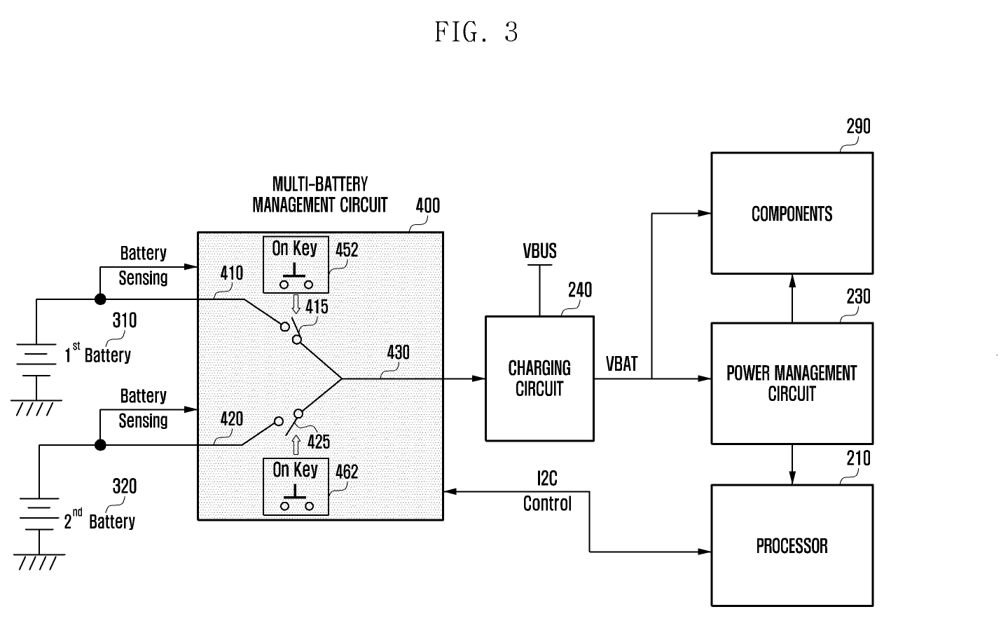

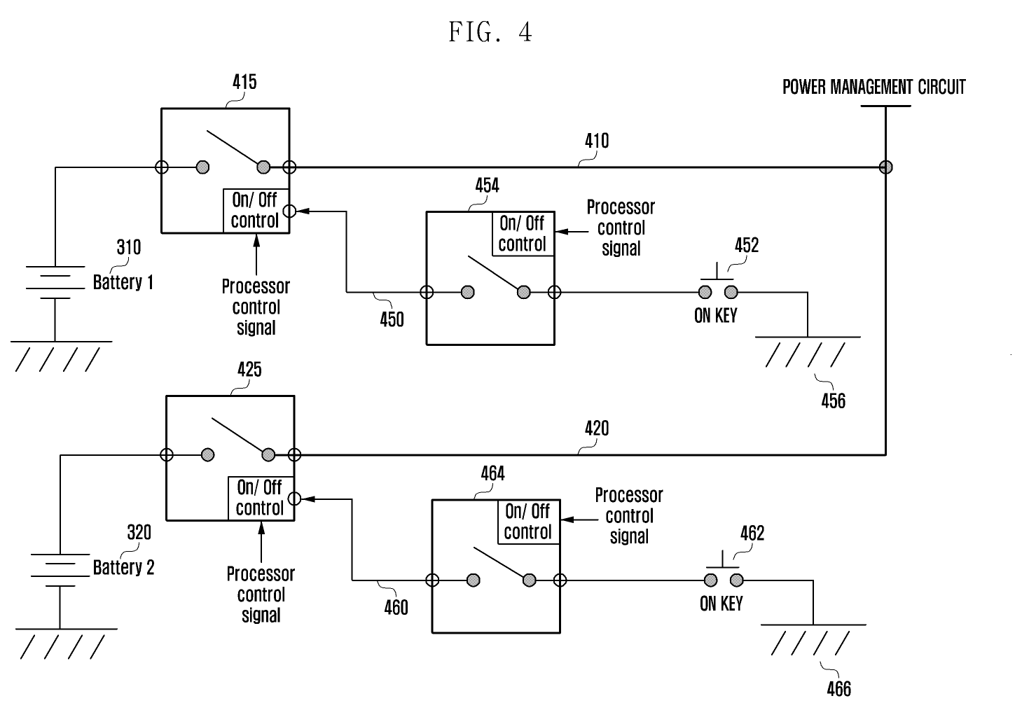

The circuit structure of the multi-battery management circuit 400 is described in more detail with reference to FIGS. 3 and 4.

According to an embodiment, the multi-battery management circuit 400, the charging circuit 240, and/the power management circuit 230 may include one or more circuits.

According to an embodiment, the memory 220 may include volatile memory and nonvolatile memory, and may temporarily or permanently store a variety of data. The memory 220 may include at least some of the components and/or functions of the memory 130 of FIG. 1, and may store the program 140 of FIG. 1.

According to an embodiment, the memory 220 may store various instructions that may be performed by the processor 210. These instructions may include control instructions, such as arithmetic and logical operations, data transfer, and/or input/output that may be recognized by the processor 210.

According to an embodiment, the processor 210 refers to a component that may perform control and/or arithmetic operation or data processing related to communication of each of the components of the electronic device 200, and may include one or more processors. The processor 210 may include at least some of the components and/or functions of the processor 120 of FIG. 1. The processor 210 may be operatively, functionally, and/or electrically connected to at least some of the components of the electronic device 200, such as the multi-battery management circuit 400, the power management circuit 230, the charging circuit 240, and the memory 220.

According to an embodiment, the processor 210 may not be limited to computational and data processing functions that may be implemented on the electronic device 200. However, herein, various embodiments that transition at least one battery path to a disconnection mode based on a battery state (e.g., state of health (SoH)) upon power-off are described. Operations of the processor 210 described below may be performed by loading the instructions stored in the memory 220. Herein, description that the processor 210 may perform a predetermined operation may be interpreted as the meaning that an instruction (or computer program) that causes the electronic device 200 (or processor 210) to perform the operation is stored in the memory 220 (e.g., non-volatile memory, storage). At least some of the operations of the processor 210 described below may be operations of the multi-battery management circuit 400 or the power management circuit 230 according to a control signal of the processor 210.

According to an embodiment, the processor 210 may use the power that is output from at least one of the plurality of batteries 300 (e.g., first battery 310, second battery 320) to control the power to be supplied to each component of the electronic device 200 in a normal mode. Here, the normal model may represent a general operating state of the electronic device 200 when powered on, rather than a disconnection mode for a specific battery. The processor 210 may switch a battery to supply the power using various algorithms that enable the power consumption of the plurality of batteries 300 to be balanced. The power management circuit 230 controls a battery switch arranged in each battery path to be turned on/off according to the control signal of the processor 210, such that the power may be supplied from the specific battery.

According to an embodiment, the processor 210 may control a battery path of at least one battery to transition to a disconnection mode when the electronic device 200 is powered off.

According to an embodiment, the processor 210 may detect a power-off event of the electronic device 200. Here, the power-off event may occur when the user turns off the power according to a graphical user interface (GUI) or external key input, or when the user turns off the power due to capacity of each battery being discharged to be less than or equal to a reference value.

According to an embodiment, in response to the power-off event, the processor 210 may identify state information of each of the plurality of batteries 300. Here, the state information of the battery may include a state of health (SoH). The SoH may include information indicating available capacity in a current state compared to the rated capacity of a rechargeable battery. According to an embodiment, a value of the SoH may gradually decrease as the battery is used, and the electronic device 200 may measure the SoH using various methods, such as measuring the voltage or current of each battery, measuring the change in internal resistance, and measuring the charge and discharge capacity. In various embodiments of the disclosure, the state information of the battery is not limited to the SoH, and may further include a variety of information, such as battery level information, a state of charge (SoC), a state of power (SoP), a depth of discharge (DoD), a C-rate, internal impedance, or a rated lifespan.

According to an embodiment, the processor 210 may compare state information of each of the batteries 300, and may select at least one battery to be used for power-off sequence corresponding to the power-off event. For example, the power-off sequence may include operations of terminating a running application and process, cleaning up a file system, storing necessary data in the nonvolatile memory 220, or deactivating each hardware component, but is not limited thereto. The processor 210 may determine a battery with highest state information (e.g., SoH) among the batteries 300 as a battery to be used for the power-off sequence.

According to an embodiment, the processor 210 may control remaining at least one battery other than at least one battery to be used for the power-off sequence to transition to the disconnection mode. The processor 210 may control an on-key path corresponding to a battery path of the remaining at least one battery to be connected to a corresponding battery switch. For example, when the electronic device 200 includes two batteries (e.g., first battery 310 and second battery 320), and the SoH of the first battery 310 is higher than the SoH of the second battery 320, the processor 210 may transmit, to the multi-battery management circuit 400, a control signal instructing the battery path of the second battery 320 to transition to the disconnection mode. In response to the control signal of the processor 210, the multi-battery management circuit 400 may close the second on-key path switch. Therefore, the second on-key path may be connected to the second battery path, so a switching control signal for a switch of the second battery 320 may be delivered depending on press or release of the on-key. When the second battery 320 is switched to the disconnection mode, that is, when the switch of the second battery 320 is connected to the second on-key path, a control signal (e.g., low signal) corresponding to a voltage level of the ground may be delivered to the switch of the second battery 320 through the second on-key path upon pressing the on-key, and the switch of the second battery 320 may be closed in response to a control signal corresponding to the voltage level of the ground.

In the disclosure, as described above, an operation of transitioning the battery path to the disconnection mode is described as being performed by the multi-battery management circuit 400 in response to the control signal of the processor 210, but various embodiments of the disclosure are not limited thereto. For example, the multi-battery management circuit 400, the power management circuit 230, and/or the charging circuit 240 may directly transition the battery path of at least one battery to the disconnection mode if a predetermined condition (e.g., detection of power-off event) is satisfied, even without receiving the control signal from the processor 210.

According to an embodiment, the processor 210 may perform the power-off sequence using the power of the battery that is identified to have a higher battery state (e.g., SoH). According to an embodiment, the multi-battery management circuit 400 may close the battery switch of the battery to be used for the power-off sequence, and enables the power of the corresponding battery to be supplied to the processor 210 while the processor 210 performs the power-off sequence. The processor 210 may be turned off after completing the power-off sequence.

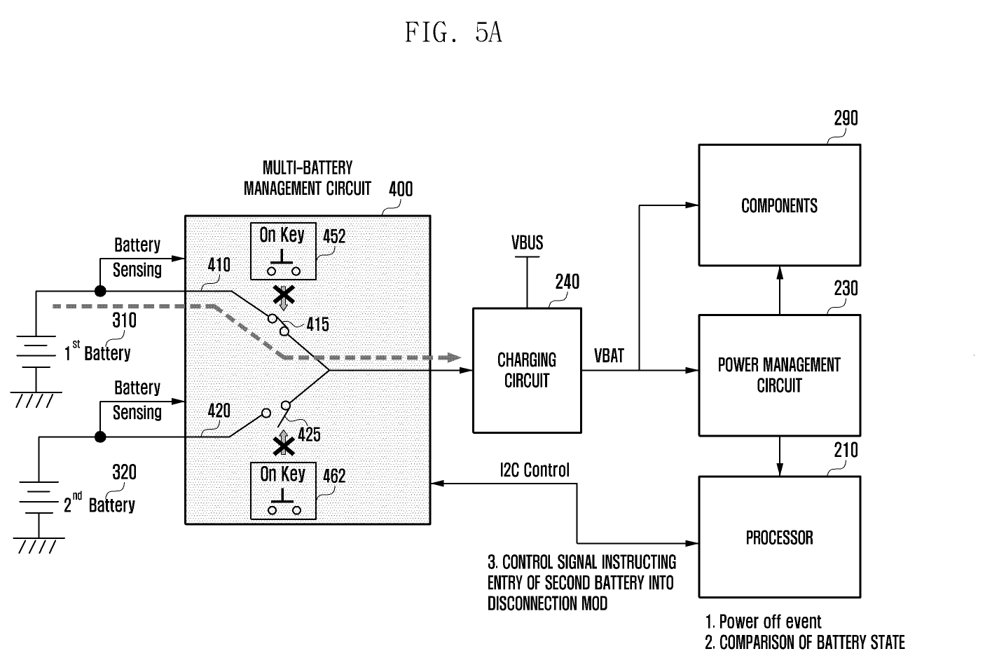

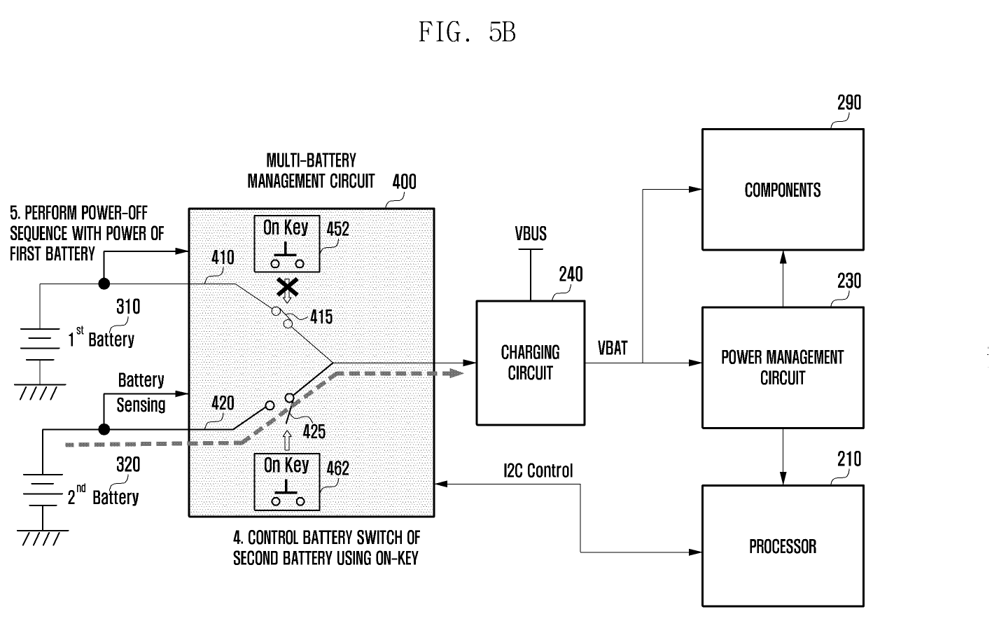

An operation of disconnecting at least one battery path when the electronic device 200 is powered off is described in detail through FIGS. 5A and 5B.

According to an embodiment, when the battery path of at least one battery is switched to the disconnection mode and the on-key is in a released state while the electronic device 200 is powered off, a battery path of a battery that is not in the disconnection mode may be electrically connected to the power management circuit 230, and a battery path of a battery that is in the disconnection mode may not be connected to the power management circuit 230. When the on-key is pressed, the battery paths of the battery that is not in the disconnection mode and the battery that is in the disconnection mode may be electrically connected to the power management circuit 230.

According to an embodiment, when the electronic device 200 is in a power-off state, the user may long-press the on-key to power on the electronic device 200. When the on-key is pressed, a battery path of at least one battery (e.g., battery with low battery state or battery not used for power-off sequence) that is switched to the disconnection mode may be connected to the power management circuit 230 and accordingly, the power of the at least one battery may be supplied to the power management circuit 230.

According to an embodiment, the processor 210 may perform a booting process using the power supplied from the power management circuit 230. The processor 210 may open an on-key path switch of a battery that is set to the disconnection mode during the booting process, and may switch the corresponding battery back to the normal mode. For example, when a peripheral operation is possible during the booting process, the processor 210 may transmit, to the multi-battery management circuit 400, a control signal instructing entry into the normal mode through inter-integrated circuit (I2C).

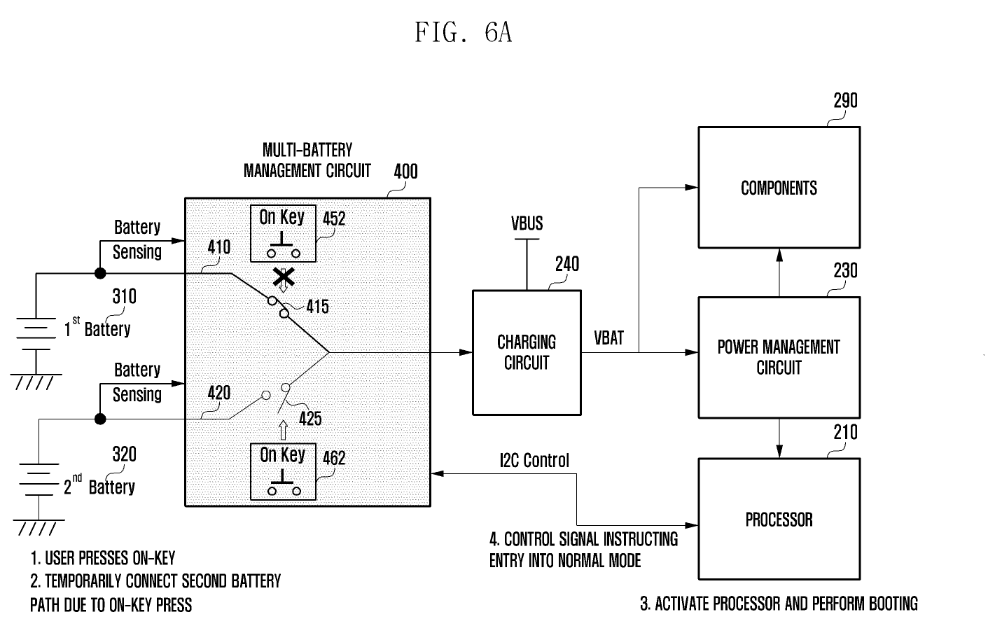

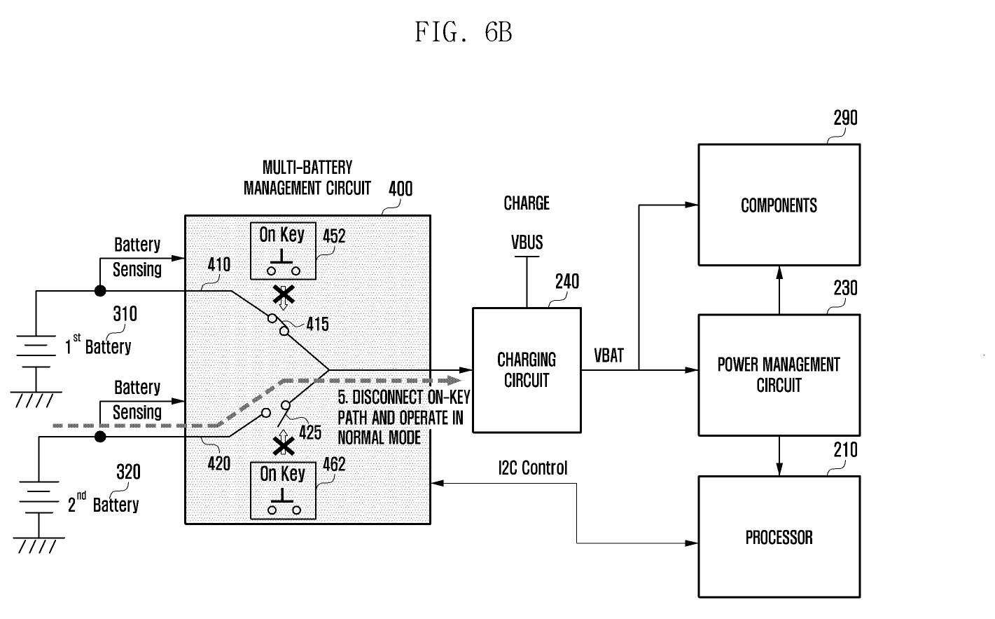

The embodiment is described in more detail with reference to FIGS. 6A and 6B.

According to an embodiment, when the external charger is connected while the electronic device 200 is in the power-off state, the charging circuit 240 may supply the charging power to the power management circuit 230. The processor 210 may perform booting using the power supplied from the power management circuit 230. The processor 210 may open the on-key path switch of the battery that is set to the disconnection mode during the booting process to switch the corresponding battery back to the normal mode.

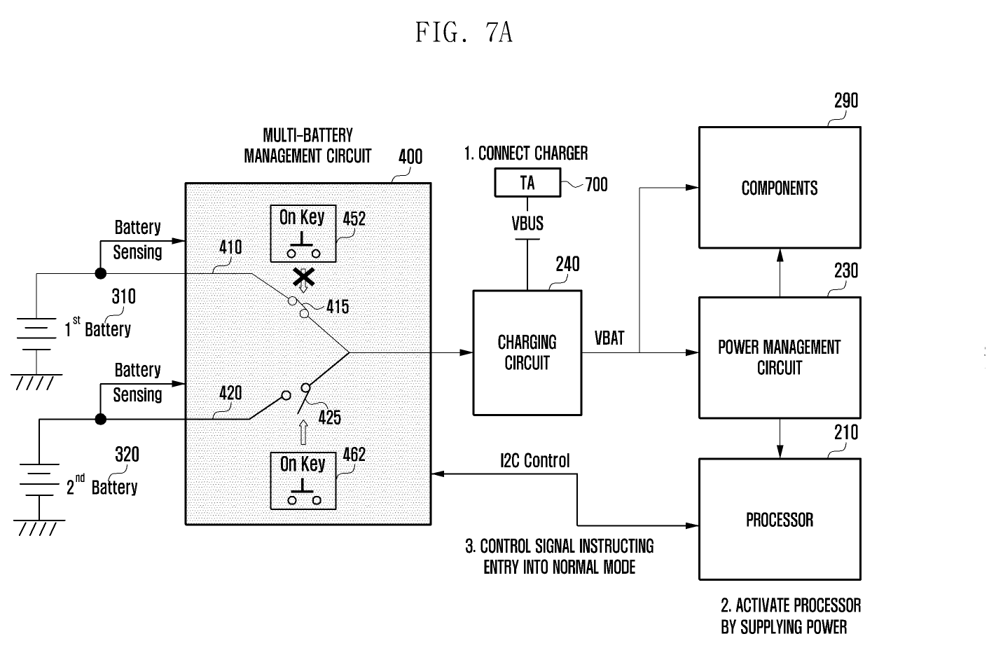

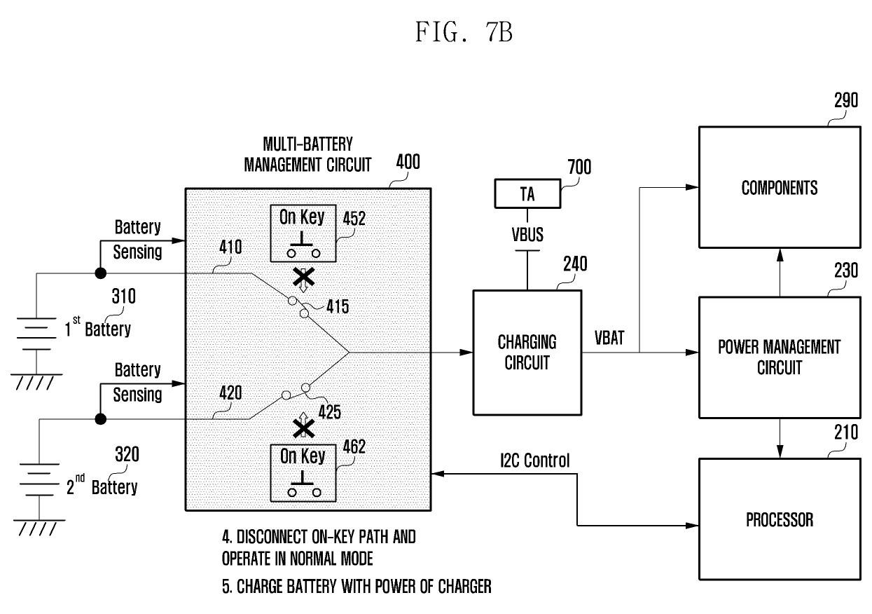

The embodiment is described in more detail with reference to FIGS. 7A and 7B.

According to an embodiment, when an alarm booting function is configured, the processor 210 may operate an alarm timer after powering off, and may perform the booting process if the timer expires. The processor 210 may select a single battery to be used for the power-off sequence based on state information of the plurality of batteries 300 during the booting process, and may control a battery path of at least one battery other than the selected battery to be switched to the disconnection mode.

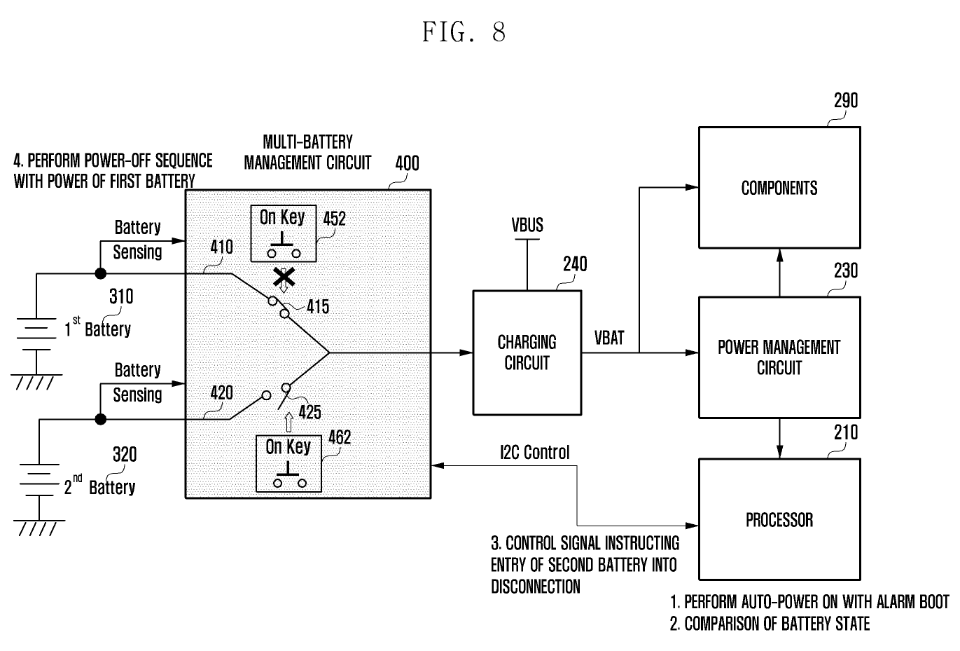

The embodiment is described in more detail with reference to FIG. 8.

Instructions to perform the operations of the processor 210 (or power management circuit 230) described above may be stored in a computer readable recording medium. The recording medium may be tangible and non-transitory. The recording medium may store at least one computer program that includes the instructions.

FIG. 3 is a block diagram including a battery path of a multi-battery of an electronic device according to an embodiment of the disclosure.

Referring to FIG. 3, the electronic device 200 (e.g., electronic device 200 of FIG. 2) may include a plurality of batteries (e.g., batteries 300 of FIG. 2), the multi-battery management circuit 400 (e.g., multi-battery management circuit 400 of FIG. 2), the charging circuit 240 (e.g., charging circuit 240 of FIG. 2), the power management circuit 230 (e.g., power management circuit 230 of FIG. 2), the processor 210 (e.g., processor 210 of FIG. 2), and various components 290. A single line that connects each circuit or component in FIG. 3 may include a plurality of lines.

According to an embodiment, the electronic device 200 may include the plurality of batteries (310, 320). Although FIG. 3 illustrates an example in which the electronic device 200 includes the first battery 310 and the second battery 320, the electronic device 200 may include three or more batteries. According to an embodiment, the electronic device 200 may be a foldable device. For example, the electronic device 200 may include a first housing and a second housing that are rotatably coupled to each other through a hinge structure, the first battery 310 may be disposed within the first housing, and the second battery 320 may be disposed within the second housing.

According to an embodiment, the multi-battery management circuit 400 may be arranged in a path between the plurality of batteries (310, 320) and the power management circuit 230 (or charging circuit 240). The multi-battery management circuit 400 may include a first battery path 410 including a discharge path through which the power of the first battery 310 is output to the power management circuit 230 or the components 290 and a charge path through which the power is supplied from an external charger 700 and the charging circuit 240 to the first battery 310, and a second battery path 420 including a discharge path through which the power of the second battery 320 is output to the power management circuit 230 or the components 290 and a charge path through which the power is supplied form the external charger and the charging circuit 240 to the second battery 320. The first battery path 410 and the second battery path 420 may be integrated into a single path 430, and connected to the power management circuit 230 (or charging circuit 240).

According to an embodiment, a first battery switch 415 that may connect or disconnect the first battery path 410 may be arranged in the first battery path 410, and a second battery switch 425 that may connect or disconnect the second battery path 420 may be arranged in the second battery path 420. According to an embodiment, when the electronic device 200 operates in the normal mode, the processor 210 may close (or turn on or short) or open (or turn off, open) the first battery switch 415 and the second battery switch 425, and may control the power of the first battery 310 or the power of the second battery 320 to be supplied to the processor 210 and various components 290. For example, in the normal mode, the multi-battery management circuit 400 may close the first battery switch 415 and open the second battery switch 425 according to a control signal of the processor 210 such that the power of the first battery 310 is supplied, or may close the second battery switch 425 and open the first battery switch 415 such that the power of the second battery 320 is supplied.

According to an embodiment, the multi-battery management circuit 400 may include a first on-key path that may close or open the first battery switch 415 and a second on-key path that may close or open the second battery switch 425 depending on press or release of an on-key. When the first on-key path includes a first on-key switch 452, the second on-key path includes a second on-key switch 462, and the user presses the on-key arranged on the outside of the electronic device 200, the first on-key switch 452 and the second on-key switch 462 may be closed. When the first on-key switch 452 is closed in a disconnection mode of the first battery 310, a control signal for closing the first battery switch 415 may be transmitted to the first battery switch 415. When the second on-key switch 462 is closed in a disconnection mode of the second battery 320, a control signal for closing the second battery switch 425 may be transmitted to the second battery switch 425.

According to an embodiment, the multi-battery management circuit 400 may include a first on-key path switch (not shown) for connecting or disconnecting the first battery path 410 (or first battery switch 415) and the first on-key path. Also, the multi-battery management circuit 400 may include a second on-key path switch (not shown) for connecting or disconnecting the second battery path 420 (or second battery switch 425) and the second on-key path.

According to an embodiment, when operating in the disconnection mode for the first battery 310 and/or second battery 320, the processor 210 may transmit a control signal to the multi-battery management circuit 400 through inter-integrated circuit (I2C). In response to receiving the control signal from the processor 210, the multi-battery management circuit 400 may connect the first on-key path and/or second on-key path connected to the first battery path 410 and/or the second battery path 420 operating in the disconnection mode. The circuit structure of the first on-key path and the second on-key path is described in more detail with reference to FIG. 4.

According to an embodiment, the power management circuit 230 may perform various operations that manage the power supplied from the plurality of batteries (310, 320) to the various components 290. The power management circuit 230 may include at least a portion of power management integrated circuit (PMIC). According to an embodiment, the power (e.g., VBAT) supplied from the batteries (310, 320) may be supplied to the various components 290 through the power management circuit 230, and some components (e.g., power amp of RF front end) may be directly supplied with the power from the batteries (310, 320) through the battery path, without going through the power management circuit 230.

According to an embodiment, the charging circuit 240 may be arranged between the multi-battery management circuit 400 and the power management circuit 230. The charging circuit 240 may supply the charging power (e.g., VBUS) to the first battery 310 and/or the second battery 320 when connected to the external charger 700.

According to an embodiment, when a power-off event occurs, the processor 210 may select one of the first battery 310 and the second battery 320 to be used for power-off sequence. The processor 210 may identify state information of the first battery 310 and the second battery 320, and may select one of the first battery 310 and the second battery 320 based on the state information. For example, state information of the battery may include a state of health (SoH). According to an embodiment, when the power-off event occurs, the processor 210 may request the multi-battery management circuit 400 to identify the SoH of each of the first battery 310 and the second battery 320, and the multi-battery management circuit 400 may identify the SoH of each of the first battery 310 and the second battery 320, and may provide the same to the processor 210. Alternatively, the processor 210 may identify the SoH of each of the first battery 310 and the second battery 320 periodically (or in real time), and may record the same in the memory. According to an embodiment, state information of the battery may further include a variety of information, such as a state of charge (SoC), a state of power (SoP), a depth of discharge (DoD), a C-rate, internal impedance, or a rated lifespan.

According to an embodiment, when the electronic device 200 is powered off, the processor 210 may identify state information (e.g., SoH) of the first battery 310 and the second battery 320, and may select one having a higher state information value. The processor 210 may control a battery path of a selected battery to be maintained and a battery path of an unselected battery to operate in the disconnection mode in which it may be connected or disconnected by an on-key. For example, when the SoH of the first battery 310 is higher, the processor 210 may transmit a control signal to the multi-battery management circuit 400 to operate in the disconnection mode of the second battery 320. In response to the control signal, the multi-battery management circuit 400 may connect the second battery path 420 (or second battery switch 425) to operate in the disconnection mode and the second on-key path. When the second battery path 420 and the second on-key path are connected, and if the on-key is pressed by the user, a control signal may be transmitted from the second on-key path to the second battery switch 425 and the second battery switch 425 may be closed. Therefore, by pressing the on-key, the power of the second battery 320 may be transmitted to the power management circuit 230. According to an embodiment, the processor 210 may perform the power-off sequence using the power of the first battery 310 through the first battery path 410 that maintains a connection state.

According to an embodiment, when an alarm booting function is configured, the electronic device 200 may perform alarm booting if an alarm timer expires after powering off, and may transition at least one battery path to the disconnection mode. For example, when performing alarm booting, the electronic device 200 may perform the power-off sequence again by activating only necessary components to switch the circuit to the disconnection mode and by connecting one of the first battery path 410 and the second battery path 420 to the on-key path.

According to an embodiment, the electronic device 200 may perform a booting process according to press of the on-key in a state in which at least one battery path is transitioned to the disconnection mode, and may transition the battery path of the battery in the disconnection mode back to the normal mode. For example, when the second battery path 420 is in a disconnection mode state, the electronic device 200 may disconnect the second on-key path connected to the second battery path 420 when powered on according to on-key press.

According to an embodiment, when the power required for booting is supplied through connection to the external charger 700 while the at least one battery path is transitioned to the disconnection mode, the electronic device 200 may perform the booting process and may transition the battery path of the battery in the disconnection mode back to the normal mode.

Although FIG. 3 illustrates the multi-battery management circuit 400, the charging circuit 240, and the power management circuit 230 as independent blocks, respectively, the multi-battery management circuit 400, the charging circuit 240, and the power management circuit 230 may not be physically separated as separate hardware. For example, at least some of the multi-battery management circuit 400, the charging circuit 240, and the power management circuit 230 may be arranged within a single chip. In this case, functions of the multi-battery management circuit 400, the charging circuit 240, and the power management circuit 230 may operate separately in a logical or hardware manner within a single chip.

FIG. 4 is a circuit diagram of an on-key path of a multi-battery management circuit according to an embodiment of the disclosure.

According to an embodiment, the electronic device 200 (e.g., electronic device 200 of FIG. 2, FIG. 3) may include a plurality of batteries, for example, the first battery 310 (e.g., first battery 310 of FIG. 2, FIG. 3) and the second battery 320 (e.g., second battery 320 of FIG. 2, FIG. 3).

According to an embodiment, the multi-battery management circuit 400 (e.g., multi-battery management circuit 400 of FIG. 2, FIG. 3) may include the first battery switch 415 (e.g., first battery switch 415 of FIG. 3) for connecting or disconnecting the first battery path 410, which is a path through which the power is output from the first battery 310 to the power management circuit 230 and the second battery switch 425 (e.g., second battery switch 425 of FIG. 3) for connecting or disconnecting the second battery path 420, which is a path through which the power is output from the second battery 320 to the power management circuit 230. According to an embodiment, in the normal mode, the processor 210 may control the first battery switch 415 and the second battery switch 425 to be turned on/off to supply the power to each component of the electronic device 200 using at least one of the first battery 310 and the second battery 320.

According to an embodiment, the multi-battery management circuit 400 may include a plurality of on-key paths corresponding to a plurality of battery switches, respectively. For example, the multi-battery management circuit 400 may include a first on-key path 450 that may be connected to the first battery switch 415 to transmit an on/off control signal, and a second on-key path 460 that may be connected to the second battery switch 425 to transmit an on/off control signal.

According to an embodiment, the first on-key path 450 may include a first on-key path switch 454 for connecting the first on-key path 450 and the first battery switch 415. For example, when receiving a control signal indicating the disconnection mode of the first battery 310 from the processor 210, the multi-battery management circuit 400 may close the first on-key path switch 454. Therefore, the first on-key path 450 may be connected to the first battery switch 415, and when the on-key is pressed, the control signal for closing first battery switch 415 may be provided to the first battery switch 415. When the first battery 310 is operating in the normal mode, the multi-battery management circuit 400 may open the first on-key path switch 454 such that the first on-key path 450 and the first battery switch 415 are disconnected from each other and accordingly, the control signal may not be transmitted to the first battery switch 415 even when the on-key is pressed/released. Similarly, when the second battery 320 is operating in the normal mode, the multi-battery management circuit 400 may open a second on-key path switch 464, and when a control signal indicating the disconnection mode of the second battery 320 is received from the processor 210, may close the second on-key path switch 464 to connect the second on-key path 460 and the second battery switch 425.

According to an embodiment, a first on-key switch 452 for connecting or disconnecting the first on-key path 450 depending on press or release of an on-key may be arranged in the first on-key path 450. Also, a second on-key switch 462 for connecting or disconnecting the second on-key path 460 depending on press or release of an on-key may be arranged in the second on-key path 460. The on-key may be arranged to be exposed on the outside of the housing (e.g., housing side surface) of the electronic device 200, and may be at least partially protruded to be pressed by the user with the hand. The on-key remains in a released state when there is no physical pressure from the outside, and may be pressed when the physical pressure is applied. In the case of pressing the on-key, both the first on-key switch 452 and the second on-key switch 462 may be structurally designed to be released.

According to an embodiment, the first on-key switch 452 and the second on-key switch 462 may be connected to grounds 456 and 466, respectively. For example, when the first battery 310 is operating in the disconnection mode, the first on-key path 450 may be disconnected as the first on-key switch 452 is open in a released state of the on-key, and accordingly the first battery switch 415 may be in an open state. When the user presses the on-key, the first on-key switch 452 may be closed and accordingly, the first on-key path 450 may be connected to the ground 456 and a low signal corresponding to a voltage level of the ground 456 may be transmitted to the first battery switch 415. The first battery switch 415 may be configured to be closed according to the low signal, and, upon on-key press, the first battery switch 415 may be closed. When the user presses and then releases again the on-key, the first on-key switch 452 may be opened to disconnect connection with the ground 456, and a high signal may be transmitted to the first battery switch 415. The first battery switch 415 may be configured to be opened according to the high signal, and may remain in the open state until the low signal is input again. Similarly, when the second battery 320 is operating in the disconnection mode, the second on-key path 460 may be disconnected as the second on-key switch 462 is open in a released state of the on-key, and accordingly the second battery switch 425 may be in an open state. When the user presses the on-key, the second on-key switch 462 may be closed and accordingly, the second on-key path 460 may be connected to the ground 466, and a low signal corresponding to a voltage level of the ground 466 may be transmitted to the second battery switch 425. When the user presses and then releases the on-key, the second on-key switch 462 may be opened to disconnect connection with the ground 466, and a high signal may be transmitted to the second battery switch 425.

FIGS. 5A and 5B illustrate an operation of disconnecting one battery path when powering off an electronic device according to various embodiments of the disclosure.

According to an embodiment, the processor 210 (e.g., processor 210 FIG. 2, FIG. 3) of the electronic device 200 (e.g., electronic device 200 of FIG. 2, FIG. 3) may detect a power-off event, and may in response to the power-off event, select a single battery to be used for power-off sequence corresponding to the power-off event from among a plurality of batteries based on state information of each of the plurality of batteries (e.g., batteries 300 of FIG. 2). The processor 210 may connect an on-key path corresponding to a battery path of at least one battery other than the selected battery to a corresponding battery switch, such that the battery switch is turned on or off depending on press or release of the on-key.

FIG. 5A illustrates an operation in a case in which, while the electronic device 200 is operating in the normal mode, the user turns off the power according to GUI or external key input or a power-off event due to battery discharge is detected.

According to an embodiment, while operating in the normal mode, the electronic device 200 may supply the required power to each component of the electronic device 200 based on the power of the first battery 310 and/or the second battery 320 by disconnecting connection between the first on-key path (e.g., first on-key path 450 of FIG. 4) and the first battery path 410 and connection between the second on-key path (e.g., first on-key path 450 of FIG. 4) and the second battery path 420, and by switching on/off the first battery switch 415 and the second battery switch 425 according to the control signal of the processor 210.

According to an embodiment, when the power-off event is detected, the processor 210 may identify the battery state of each of the first battery 310 and the second battery 320 in response to the power-off event. Here, the battery state may be a state of health (SoH), but is not limited thereto, and may further include a variety of information, such as battery level information, a state of charge (SoC), a state of power (SoP), a depth of discharge (DoD), a C-rate, internal impedance, or a rated lifespan.

According to an embodiment, as a result of identifying the battery state of each of the first battery 310 and the second battery 320, the processor 210 may identify that the battery state of the first battery 310 is higher. For example, the processor 210 may identify that the SoH of the first battery 310 is higher than the SoH of the second battery 320, which are identified from the multi-battery management circuit 400. Here, that the SoH of the first battery 310 is higher than the SoH of the second battery 320 may indicate that the available capacity of the first battery 310 in a current state is greater than the available capacity of the second battery 320. The processor 210 may select the first battery 310 with the higher battery state as the battery to be used for the power-off sequence.

According to an embodiment, the processor 210 may control the second battery 320 not used for the power-off sequence to operate in the disconnection mode in the power-off state. For example, the processor 210 may transmit, to the multi-battery management circuit 400, a control signal instructing entry of the second battery path 420 into the disconnection mode through inter-integrated circuit (I2C).

FIG. 5B illustrates an operation in which, after the processor 210 transmits, to the multi-battery management circuit 400, the control signal instructing entry of the second battery path 420 into the disconnection mode in FIG. 5A, the multi-battery management circuit 400 switches the battery path according to the control signal from the processor 210.

According to an embodiment, in response to the control signal from the processor 210 instructing entry of the second battery path 420 into the disconnection mode, the multi-battery management circuit 400 may connect the second battery switch 425 and the second on-key path to each other, such that the second battery switch 425 may be turned on/off according to an electrical signal of the second on-key path.

As described above with reference to FIG. 4, the second on-key path (e.g., 460 of FIG. 4) may include the second on-key path switch (e.g., 464 of FIG. 4) for connecting or disconnecting the second on-key path, and the second on-key path switch may be turned on/off based on the control signal of the processor 210. The multi-battery management circuit 400 may close the second on-key path switch based on the control signal of the processor 210. As the second on-key path switch is closed, the second on-key path may be connected to the second battery switch 425 and a control signal for turning on/off the second battery switch 425 depending on press or release of the on-key may be transmitted to the second battery switch 425 through the second on-key path.

According to an embodiment, when the second battery 320 is connected to the second on-key path and transitions to the disconnection mode, the second on-key path may be disconnected as the second on-key switch 462 is open in a released state of the on-key, and accordingly, the second battery switch 425 may be in an open state. When the user presses the on-key, the second on-key switch 462 may be closed and accordingly, the second on-key path may be connected to the ground, and a low signal corresponding to a voltage level of the ground may be transmitted to the second battery switch 425. The second battery switch 425 may be configured to be closed according to the low signal, and, upon on-key press, the first battery switch 415 may be closed. When the user presses and then releases again the on-key, the second on-key switch 462 may be opened to disconnect connection to the ground, and a high signal may be transmitted to the second battery switch 425. The second battery switch 425 may be configured to be opened according to the high signal, and may remain in the open state until the low signal is input again. By configuring the circuit in this way in the disconnection mode, although processor 210 remains in the open state, the battery path of the second battery 320 may be switched to be connected to the power management circuit 230 by pressing the on-key in a hardware manner.

According to an embodiment, the processor 210 may perform power-off sequence corresponding to the power-off event using the power of the first battery 310 that is identified to have a higher battery state (e.g., SoH). For example, the power-off sequence may include operations of terminating a running application and process, cleaning up a file system, storing necessary data in nonvolatile memory, or deactivating each hardware component, but is not limited thereto. According to an embodiment, the multi-battery management circuit 400 may close the first battery switch 415, and may supply the power of the first battery 310 to the processor 210 while the processor 210 performs the power-off sequence. The processor 210 may be turned off after completing the power-off sequence. According to an embodiment, the first battery switch 415 may remain closed in the power-off state. Therefore, when there is an operation that is performed in the power-off state such as alarm booting, the required operation may be performed using the power supplied from the first battery 310.

As such, when the second battery 320 transitions to the disconnection mode, the second battery 320 may be circuit-wisely separated from the system, so there may be no practical occurrence of leakage current. Also, the power of the second battery 320 may be implemented to operate in a low active mode upon press of the on-key and to be controllable in a hardware manner although the processor 210 is not activated.

FIGS. 6A and 6B illustrate an operation of connecting a battery path that was disconnected when turning on due to on-key press of an electronic device according to various embodiments of the disclosure.

According to an embodiment, the electronic device 200 (e.g., electronic device 200 of FIG. 2, FIG. 3) may identify a battery with a low battery state (e.g., SoH) when the power is turned off, and may set the corresponding battery path to the disconnection mode. For example, the electronic device 200 may connect a battery switch (e.g., second battery switch 425 of FIGS. 5A and 5B) of a battery path to be set to the disconnection mode to an on-key path (e.g., second on-key path 460 of FIG. 4), and may configure on/off of the battery switch to be controllable depending on press or release of an on-key.

FIG. 6A illustrates an operation when the power is turned on through press of an on-key after transitioning the second battery path 420 of the second battery 320 to the disconnection mode as shown in FIGS. 5A and 5B.

According to an embodiment, through the process of FIGS. 5A and 5B, the second battery path 420 may be connected to the second on-key path and accordingly, the leakage current of the second battery 320 may be blocked and the capacity of the second battery 320 may be maintained to be sufficient although the electronic device 200 remains in the off-state for a long period of time.

According to an embodiment, when the user presses the on-key while the electronic device 200 is in the off-state, the second battery path 420 may be temporarily connected. For example, upon the on-key press, the second on-key switch 462 closes and, as the second on-key switch 462 is closed, the second on-key path may be connected to the ground, and a control signal (e.g., low signal) corresponding to a voltage level of the ground may be transmitted to the second battery switch 425. The second switch may transition to the closed state according to the control signal that is transmitted through the second on-key path and accordingly, the second battery path 420 may be connected between the second battery 320 and the power management circuit 230.

According to an embodiment, the power management circuit 230 may be supplied with the power from the second battery 320 through the second battery path 420 to generate the system power, and may supply the power to the processor 210. The processor 210 may perform the booting process using the supplied power.

According to an embodiment, when a peripheral operation is possible during the booting process, the processor 210 may transmit, to the multi-battery management circuit 400, a control signal instructing entry into the normal mode through I2C. Here, a case in which the peripheral operation is possible may occur in a hardware component initialization stage during the booting process of the electronic device 200, and may indicate a point in time at which a peripheral device is set to an operable state. That is, if it comes to a point in time at which the multi-battery management circuit 400 is controllable through the I2C during the booting process, the processor 210 may transmit the control signal instructing entry into the normal mode to the multi-battery management circuit 400.

FIG. 6B illustrates an operation in which, after the processor 210 transmits, to the multi-battery management circuit 400, the control signal instructing entry of the second battery path 420 into the normal mode in FIG. 6A, the multi-battery management circuit 400 switches the battery path according to the control signal.

According to an embodiment, in response to receiving the control signal instructing the entry into the normal mode from the processor 210, the multi-battery management circuit 400 may transition the second battery path 420 from the disconnection mode to the normal mode.

According to an embodiment, the multi-battery management circuit 400 may open the second on-key path switch 464 of the second on-key path, thereby disconnecting connection between the second battery switch 425 and the second on-key path. Therefore, although the second on-key switch 462 closes by pressing the on-key, the low signal corresponding to the voltage level of the ground may not be transmitted to the second battery switch 425.

According to an embodiment, if the second battery path 420 transitions to the normal mode, the processor 210 may switch the first battery switch 415 and the second battery switch 425 to the normal mode to supply the power to the power management circuit 230. According to an embodiment, in the case of entering the normal mode, press or release of the on-key switch may be configured to not be involved in the battery path 410, 420. For example, a low active operation due to press of the on-key switch may be eliminated in path switch control. According to an embodiment, the processor 210 may perform normal multi-battery managing by entering the normal mode, and may provide the power of each battery (310, 320) to the power management circuit 230 and each of the components 290. As in FIGS. 6A and 6B, when the electronic device 200 is powered on, the electronic device 200 may operate using the power of the second battery 320 although the first battery 310 is fully discharged since the leakage current of the second battery 320 is blocked in the power-off state and accordingly, the power-off state is maintained for a long period of time.

FIGS. 7A and 7B illustrate an operation of connecting a battery path that was disconnected when turning on due to connection of an external charger to an electronic device according to various embodiments of the disclosure.

FIG. 7A illustrates an operation of when the power is turned on through connection to the external charger 700 after transitioning the second battery path 420 of the second battery 320 to the disconnection mode as in FIGS. 5A and 5B.

According to an embodiment, the electronic device 200 may be supplied with the charging power (e.g., VBUS) from the external charger 700 (travel adapter (TA)) in a wired or wireless manner. The charging circuit 240 may supply the power supplied from the external charger 700 to the power management circuit 230, and the system power may be generated by the power management circuit 230 and accordingly, the processor 210 may initiate booting. According to an embodiment, the electronic device 200 may supply the power to the power management circuit 230 by temporarily charging the VBAT of the charging circuit with the VBUS of the external charger 700. The system power generated through power supply from the external charger 700 may be provided for booting of the processor 210 and the operation of the various components 290.

According to an embodiment, when a peripheral operation is possible during the booting process, the processor 210 may transmit, to the multi-battery management circuit 400, a control signal instructing entry into the normal mode through I2C. Here, a case in which the peripheral operation is possible may occur in a hardware component initialization stage during the booting process of the electronic device 200, and may indicate a point in time at which a peripheral device is set to an operable state.

FIG. 7B illustrates an operation in which the multi-battery management circuit 400 switches the battery path according to the control signal instructing entry of the second battery path 420 into the normal mode.

According to an embodiment, in the case of receiving the control signal instructing entry into the normal mode from the processor 210, the multi-battery management circuit 400 may transition the second battery path 420 from the disconnection mode to the normal mode.

According to an embodiment, the multi-battery management circuit 400 may open the second on-key path switch 464 of the second on-key path to disconnect connection between the second battery switch 425 and the second on-key path. Therefore, although the second on-key switch 462 closes by pressing the on-key, a low signal corresponding to the voltage level of the ground may not be transmitted to the second battery switch 425.

According to an embodiment, if the second battery path 420 transitions to the normal mode, the processor 210 may initiate charging of the first battery 310 and the second battery 320 using the charging power of the external charger 700.

FIG. 8 illustrates an operation of disconnecting one battery path when an electronic device performs alarm booting according to an embodiment of the disclosure.

According to an embodiment, when an alarm booting function is configured, the electronic device 200 (e.g., electronic device 200 of FIG. 2, FIG. 3) may perform alarm booting if an alarm timer expires after powering off, and may transition at least one battery path to the disconnection mode. For example, when the power is turned off in a state in which the disconnection mode for the battery path is not configured, the electronic device 200 may operate the timer and, if the timer expires, may perform alarm booting to transition at least one of battery paths to the disconnection mode and then be turned off again.

According to an embodiment, the electronic device 200 may remain in the power-off state for a period of time determined by the timer in the power-off state. Here, the period of time determined by the timer may be a predetermined specific period of time, or may be a period of time that is determined by the processor 210 in consideration of the charging capacity of the first battery 310 and the second battery 320 when the power is turned off. When alarm booting is configured, the processor 210 may be activated in a low power mode to manage the timer.

According to an embodiment, when the time expires, the electronic device 200 may perform an auto-power-on operation. In this case, unlike normal booting, the electronic device 200 may activate only some components required to switch the circuit to the disconnection mode.

According to an embodiment, the processor 210 may identify the battery state (e.g., SoH) of each of the first battery 310 and the second battery 320 from a bootloader, and may select a battery with a low battery state. To allow the second battery 320 with the low battery state to enter the disconnection mode, the processor 210 may deliver a control signal instructing entry into the disconnection mode to the multi-battery management circuit 400 through I2C.

According to an embodiment, in response to the control signal instructing entry of the second battery path 420 into the disconnection mode from the processor 210, the multi-battery management circuit 400 may connect the second battery switch 425 and the second on-key path to each other such that the second battery switch 425 may be turned on/off according to the electrical signal of the second on-key path. For example, the multi-battery management circuit 400 may close the second on-key path switch 464 based on the control signal of the processor 210. As the second on-key path switch 464 is closed, the second on-key path may be connected to the second battery switch 425, and a control signal for turning on/off the second battery switch 425 depending on press or release of the on-key may be transmitted to the second battery switch 425 through the second on-key path.

According to an embodiment, when entry of the second battery path 420 into the disconnection mode is completed, the processor 210 may turn off alarm booting settings and may perform the power-off sequence. In this case, the processor 210 may perform the power-off sequence using the power of the first battery 310.

As such, by connecting the at least one battery path and the on-key path through alarm booting, the leakage current of a corresponding battery may be practically blocked. Therefore, when the power-off state is maintained for a long period of time, it is possible to maintain the capacity of at least one battery and to prevent over-discharging.

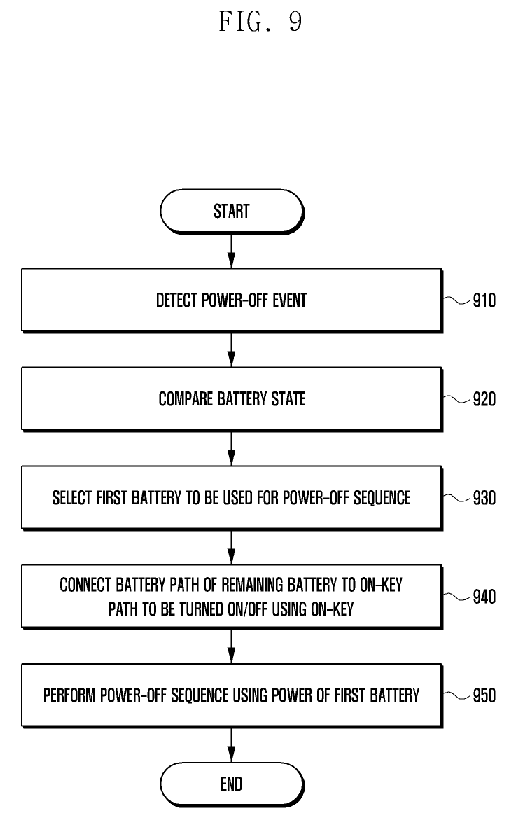

FIG. 9 is a flowchart of a multi-battery control method of an electronic device according to an embodiment of the disclosure.

The method illustrated in FIG. 9 may be performed by an electronic device (e.g., electronic device 200 of FIG. 2, FIG. 3), and description related to the technical features described above may be omitted. The electronic device may include components described above with reference to FIG. 2 and/or FIG. 3, such as the plurality of batteries 300, the multi-battery management circuit 400, the charging circuit 240, and the power management circuit 230.

According to an embodiment, in operation 910, the electronic device may detect a power-off event. Here, the power-off event may occur when the user turns off the power according to GUI or external key input, or turns off the power since the capacity of each battery is discharged to be less than or equal to a reference value.

According to an embodiment, in operation 920, in response to the power-off event, the electronic device may identify state information of each of a plurality of batteries. Here, state information of the battery may include a state of health (SoH), but is not limited thereto, and may further include a variety of information, such as battery level information, a state of charge (SoC), a state of power (SoP), a depth of discharge (DoD), a C-rate, internal impedance, or a rated lifespan.

According to an embodiment, in operation 930, the electronic device may select a battery to be used for power-off sequence based on the state information of each of the plurality of batteries. For example, the electronic device may determine a battery with the highest state information (e.g., SoH) among the batteries as a battery to be used for the power-off sequence.

According to an embodiment, in operation 940, the electronic device may connect a battery path of remaining at least one battery other than the battery selected in operation 930 to the on-key path to be turned on/off using the on-key. For example, the electronic device may close an on-key path switch arranged in an on-key path corresponding to each of the at least one battery. Accordingly, the on-key path may be connected to the battery path, and a switching control signal for a battery switch may be delivered depending on press or release of the on-key. For example, upon press of the on-key, a control signal (e.g., low signal) corresponding to a voltage level of the ground may be delivered to the battery switch through the on-key path, the battery switch may be closed according to the control signal corresponding to the voltage level of the ground, and the corresponding battery may be electrically connected to a power management circuit.

According to an embodiment, in operation 950, the electronic device may perform the power-off sequence using the power of the battery selected in operation 930. The electronic device may be turned off after completing the power-off sequence.

An electronic device according to various embodiments of the disclosure may include an on-key exposed to the outside of a housing and configured to be capable of being pressed or released by physical pressure, a plurality of batteries, a power management circuit configured to manage power supplied from the batteries to each component of the electronic device, a multi-battery management circuit, and at least one processor.

According to an embodiment, the multi-battery management circuit may include a plurality of battery switches arranged on a plurality of battery paths connected to the plurality of batteries, respectively, and configured to connect or disconnect the battery paths, and a plurality of on-key switches arranged on on-key paths corresponding to the plurality of battery switches, respectively, and configured to connect or disconnect each of the on-key paths depending on press or release of the on-key.

According to an embodiment, the memory may store instructions that may be executed by at least one processor, and when executed, cause the electronic device to detect a power-off event of the electronic device, in response to the power-off event, select a single battery to be used for power-off sequence corresponding to the power-off event from among the plurality of batteries based on state information of each of the plurality of batteries, and connect an on-key path corresponding to a battery path of at least one battery other than the selected battery to a battery switch corresponding to the battery path of the at least one battery, such that the battery switch closes and opens depending on press or release of the on-key.

According to an embodiment, state information of the battery may include a state of health (SoH), and the memory may store instructions that cause the electronic device to identify the SoH of each of the plurality of batteries, and to select a battery with the highest SoH to be used for the power-off sequence.

According to an embodiment, the multi-battery management circuit may further include a plurality of on-key path switches configured to connect or disconnect the on-key paths, respectively, and the multi-battery management circuit may control the on-key path switch of at least one battery other than the selected battery to be closed, such that a switching control signal is delivered to the battery switch depending on press or release of the on-key.

According to an embodiment, the on-key switch may be arranged between the ground and the on-key path switch, and when the on-key path switch is in a closed state, a control signal corresponding to a voltage level of the ground may be delivered to the battery switch through the on-key path upon press of the on-key, and the battery switch may switch to the closed state.

According to an embodiment, the multi-battery management circuit may control a battery switch arranged in a battery path of the selected battery to be closed, such that power of the selected battery is supplied to the power management circuit during the power-off sequence.

According to an embodiment, when the on-key is in a released state while the electronic device is in a power-off state, the selected battery may be connected to the power management circuit and at least one battery other than the selected battery may not be connected to the power management circuit, and when the on-key is pressed, the selected battery and the at least one battery other than the selected battery may be connected to the power management circuit.

According to an embodiment, when the on-key is pressed while the electronic device is in the power-off state, the power of at least one battery other than the selected battery may be supplied to the power management circuit, and the processor may perform booting using the power supplied from the power management circuit.

According to an embodiment, the memory may store instructions that control the electronic device to open at least one on-key path switch corresponding to at least one battery other than the selected battery in a booting process.

According to an embodiment, the electronic device may further include a charging circuit arranged between the plurality of batteries and the power management circuit, and configured to manage charging power of an external charger, and when the charging power is supplied from the external charger while the electronic device is in the power-off state, the charging circuit may supply the charging power to the power management circuit, and the processor may perform booting using the power supplied from the power management circuit.

According to an embodiment, the memory may store instructions that cause the electronic device to when alarm booting is set, operate a timer after powering off the electronic device, to perform a booting process if the timer expires, and to select a single battery to be used for power-off sequence corresponding to the power-off event from among the plurality of batteries and connect an on-key path corresponding to a battery path of at least one battery other than the selected battery to a corresponding battery switch, in the booting process.

According to an embodiment, the memory may store instructions that cause the electronic device to determine whether to connect the on-key path to the battery switch based on a current charging state of at least one of the first battery and the second battery.

According to an embodiment, the housing may include a first housing, and a second housing rotatably connected to the first housing, and at least one of the plurality of batteries may be accommodated within the first housing, and the remaining at least one may be accommodated within the second housing.

A multi-battery control method of an electronic device according to various embodiments of the disclosure may include detecting a power-off event of the electronic device, in response to the power-off event, identifying state information of each of a plurality of batteries, selecting a single battery to be used for power-off sequence corresponding to the power-off event, based on the state information of each of the plurality of batteries, and connecting an on-key path corresponding to a battery path of at least one battery other than the selected battery to a battery switch corresponding to the battery path of the at least one battery, such that the battery switch closes or opens depending on press or release of the on-key.

According to an embodiment, state information of the battery may include a state of health (SoH), and the selecting the single battery may include selecting a battery with the highest SoH from among the plurality of batteries to use for the power-off sequence.

According to an embodiment, the connecting the on-key path corresponding to the battery path of at least one battery other than the selected battery to the corresponding battery switch may include controlling the on-key path switch of the at least one battery other than the selected battery to be closed, and a switching control signal may be delivered to the battery switch depending on press or release of the on-key.

According to an embodiment, the method may further include controlling a battery switch arranged in a battery path of the selected battery to be closed, such that power of the selected battery is supplied to a power management circuit during the power-off sequence.

According to an embodiment, when the on-key is pressed while the electronic device is in a power-off state, power of at least one battery other than the selected battery may be supplied to the power management circuit, and the method may further include performing booting using the power supplied from the power management circuit.

According to an embodiment, the method may further include controlling at least one on-key path switch corresponding to at least one battery other than the selected battery to be opened in the booting process.

According to an embodiment, the method may further include, when alarm booting is set, operating a timer after powering off the electronic device, performing a booting process if the timer expires, and selecting a single battery to be used for power-off sequence corresponding to the power-off event from among the plurality of batteries and connecting an on-key path corresponding to a battery path of at least one battery other than the selected battery to a corresponding battery switch, in the booting process.

A non-transitory computer-readable recording medium according to various embodiments of the disclosure may store instructions for performing operations of detecting a power-off event of an electronic device, in response to the power-off event, identifying state information of each of a plurality of batteries, selecting a single battery to be used for power-off sequence corresponding to the power-off event, based on the state information of each of the plurality of batteries, and connecting an on-key path corresponding to a battery path of at least one battery other than the selected battery to a battery switch corresponding to the battery path of the at least one battery, such that the battery switch closes or opens depending on press or release of the on-key.

An electronic device according to various embodiments disclosed herein may be a device in various forms. The electronic device may include, for example, a portable communication device (e.g., smartphone), a computer device, a portable multimedia device, a portable medical device, a camera, a wearable device, or a home appliance device. The electronic device according to an embodiment herein is not limited to the above-described devices.

Various embodiments and terms used herein are not construed to limit technical features disclosed herein to specific embodiments, and should be understood to include various modifications, equivalents, or substitutions of a corresponding embodiment. In describing drawings, like reference numerals refer to like components. The singular forms "a," "an," and "the" of noun corresponding to an item are intended to include one item or a plurality of items, unless the context clearly indicates otherwise. Herein, each of the expressions, "A or B," "at least one of A and B," "at least one of A or B," "A, B, or C," "at least one of A, B, and C," "at least one of A, B, or C," and the like may include any possible combinations of items listed with a corresponding expression among the expressions. Terms "first," "second," etc., are simply used to distinguish one component from another component and do not limit the corresponding components in another aspect (e.g., importance or order). When a (e.g., first) component is described to be "coupled" or "connected to" another (e.g., second) component along with the term "functionally" or "communicatively," the component may be directly (e.g., wiredly) connected to the other component or may be connected through a third component.

The term "module" used in various embodiments herein may include a unit implemented as hardware, software, or firmware, and may be interchangeably used with the terms, for example, logic, logic block, part, and circuit. The module may be an integrally configured part or a minimal unit of the part that performs one or more functions or a portion thereof. For example, according to an embodiment, the module may be implemented in a form of an application-specific integrated circuit (ASIC).

Various embodiments disclosed herein may be implemented as software (e.g., program 140) that includes one or more commands stored in a storage medium (e.g., internal memory 136 or external memory 138) readable by a machine (e.g., electronic device 101). For example, a processor (e.g., processor 120) of the machine (e.g., electronic device 101) may call and execute at least one command among the one or more commands stored in the storage medium, which enables the device to operate to perform at least one function in response to the called at least one command. The one or more commands may include a code generated by a compiler or a code executable by an interpreter. The storage medium readable by the device may be provided in the form of a non-transitory storage medium. Here, "non-transitory" simples indicates that the storage medium is a tangible device and does not include a signal (e.g., electromagnetic wave). This term does not distinguish a case in which data is semi-permanently stored in the storage medium from a case in which the data is transitorily stored in the storage medium.

According to an embodiment, the method according to various embodiments disclosed herein may be included in a computer program product and thereby provided. The computer program product may be traded between a seller and a purchaser. The computer program product may be distributed in a form of a storage medium readable by machine (e.g., compact disc read only memory (CD-ROM)) or may be distributed (e.g., downloaded or uploaded) directly or online through an application store (e.g., PlayStore^{TM}) or between two user devices (e.g., smartphones). In the case of online distribution, at least a portion of the computer program product may be at least transitorily stored or temporarily generated in a server of a manufacturer, a server of application store, or a storage medium readable by machine such as memory of a repeater server.

According to various embodiments, each component (e.g., module or program) of the above-described components may include a single entity or multiple entities, and some of the multiple entities may be separately arranged in different components. According to various embodiments, one or more of the above-described components may be omitted, or one or more other components may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

1. An electronic device comprising:
an on-key exposed to an outside of a housing and configured to be capable of being pressed or released by physical pressure;
a plurality of batteries;
a power management circuit configured to manage power supplied from the batteries to each component of the electronic device;
a multi-battery management circuit;
memory, comprising one or more storage media, storing instructions; and
at least one processor communicatively coupled to the memory,
wherein the multi-battery management circuit comprises:
a plurality of battery switches arranged on a plurality of battery paths connected to the plurality of batteries, respectively, and configured to connect or disconnect the battery paths, and
a plurality of on-key switches arranged on on-key paths corresponding to the plurality of battery switches, respectively, and configured to connect or disconnect each of the on-key paths depending on press or release of the on-key, and
wherein the instructions, when executed by the at least one processor individually or collectively, cause the electronic device to:
detect a power-off event of the electronic device,
in response to the power-off event, select a single battery to be used for power-off sequence corresponding to the power-off event from among the plurality of batteries based on state information of each of the plurality of batteries, and
connect an on-key path corresponding to a battery path of at least one battery other than the selected battery to a battery switch corresponding to the battery path of the at least one battery, such that the battery switch closes and opens depending on press or release of the on-key.

2. The electronic device of claim 1,
wherein state information of the battery includes a state of health (SoH), and
wherein the instructions, when executed by the at least one processor individually or collectively, further cause the electronic device to:
identify the SoH of each of the plurality of batteries, and
select a battery with a highest SoH to be used for the power-off sequence.

3. The electronic device of claim 1,
wherein the multi-battery management circuit further comprises:
a plurality of on-key path switches configured to connect or disconnect the on-key paths, respectively, and
wherein the multi-battery management circuit is configured to control, from among the plurality of on-key path switches, an on-key path switch of at least one battery other than the selected battery to be closed, such that a switching control signal is delivered to the battery switch depending on press or release of the on-key.

4. The electronic device of claim 3,
wherein the on-key switch is arranged between the ground and the on-key path switch, and
wherein, when the on-key path switch is in a closed state, a control signal corresponding to a voltage level of the ground is delivered to the battery switch through the on-key path upon press of the on-key, and the battery switch switches to the closed state.

5. The electronic device of claim 1, wherein the multi-battery management circuit is configured to control a battery switch arranged in a battery path of the selected battery to be closed, such that power of the selected battery is supplied to the power management circuit during the power-off sequence.

6. The electronic device of claim 1,
wherein, when the on-key is in a released state while the electronic device is in a power-off state, the selected battery is connected to the power management circuit and at least one battery other than the selected battery is not connected to the power management circuit, and
wherein, when the on-key is pressed, the selected battery and the at least one battery other than the selected battery are connected to the power management circuit.

7. The electronic device of claim 1, wherein the instructions, when executed by the at least one processor individually or collectively, further cause the electronic device to open at least one on-key path switch corresponding to at least one battery other than the selected battery in a booting process of the electronic device.

8. The electronic device of claim 1, further comprising:
a charging circuit arranged between the plurality of batteries and the power management circuit, and configured to manage charging power of an external charger,
wherein, when the charging power is supplied from the external charger while the electronic device is in a power-off state, the charging circuit is configured to supply the charging power to the power management circuit, and
wherein the processor is configured to perform booting using the power supplied from the power management circuit.

9. The electronic device of claim 1, wherein the instructions, when executed by the at least one processor individually or collectively, further cause the electronic device to:
when alarm booting is set, operate a timer after powering off the electronic device;
perform a booting process if the timer expires; and
select a single battery to be used for power-off sequence corresponding to the power-off event from among the plurality of batteries and connect an on-key path corresponding to a battery path of at least one battery other than the selected battery to a corresponding battery switch, in the booting process of the electronic device.

10. The electronic device of claim 1, wherein the instructions, when executed by the at least one processor individually or collectively, further cause the electronic device to determine whether to connect the on-key path to the battery switch based on a current charging state of at least one of a first battery and a second battery.

11. A multi-battery control method of an electronic device, the method comprising:
detecting a power-off event of the electronic device;
in response to the power-off event, identifying state information of each of a plurality of batteries;
selecting a single battery to be used for power-off sequence corresponding to the power-off event, based on state information of each of the plurality of batteries; and
connecting an on-key path corresponding to a battery path of at least one battery other than the selected battery to a battery switch corresponding to the battery path of the at least one battery, such that the battery switch closes or opens depending on press or release of an on-key of the electronic device.

12. The method of claim 11,
wherein state information of the battery includes a state of health (SoH), and
wherein the selecting the single battery comprises selecting a battery with a highest SoH from among the plurality of batteries to use for the power-off sequence.

13. The method of claim 11,
wherein the connecting the on-key path corresponding to the battery path of at least one battery other than the selected battery to the corresponding battery switch comprises controlling an on-key path switch of the at least one battery other than the selected battery to be closed, and
wherein a switching control signal is delivered to the battery switch depending on press or release of the on-key.

14. The method of claim 11, further comprising:
controlling a battery switch arranged in a battery path of the selected battery to be closed, such that power of the selected battery is supplied to a power management circuit during the power-off sequence.

15. The method of claim 11, further comprising:
opening at least one on-key path switch corresponding to at least one battery other than the selected battery in a booting process of the electronic device.

16. The method of claim 11, further comprising:
when alarm booting is set, operating a timer after powering off the electronic device;
performing a booting process if the timer expires; and
selecting a single battery to be used for power-off sequence corresponding to the power-off event from among the plurality of batteries and connecting an on-key path corresponding to a battery path of at least one battery other than the selected battery to a corresponding battery switch, in the booting process of the electronic device.

17. The method of claim 11, further comprising:
determining whether to connect the on-key path to the battery switch based on a current charging state of at least one of a first battery and a second battery.

18. The method of claim 12, further comprising:
determining whether to connect the on-key path to the battery switch based on a current charging state of at least one of a first battery and a second battery.

19. One or more non-transitory computer-readable storage media storing one or more computer programs including computer-executable instructions that, when executed by one or more processors of an electronic device individually or collectively, cause the electronic device to perform operations, the operations comprising:
detecting a power-off event of an electronic device;
in response to the power-off event, identifying state information of each of a plurality of batteries;
selecting a single battery to be used for power-off sequence corresponding to the power-off event, based on state information of each of the plurality of batteries; and
connecting an on-key path corresponding to a battery path of at least one battery other than the selected battery to a battery switch corresponding to the battery path of the at least one battery, such that the battery switch closes or opens depending on press or release of an on-key of the electronic device.

20. The one or more non-transitory computer-readable storage media of claim 19,
wherein state information of the battery includes a state of health (SoH), and
wherein the selecting the single battery comprises selecting a battery with a highest SoH from among the plurality of batteries to use for the power-off sequence.
